(19) United States
(12) Patent Application Publication
(10) Pub. No.: US 2025/0087400 A1
(43) Pub. Date: Mar. 13, 2025

(54) SYSTEM FOR PARAMETRIC RESONANT VARYING INDUCTANCE

(71) Applicant: ELAN RESEARCH - 9456-4424 QUÉBEC INC., Granby (CA)

(72) Inventors: Benoît GUAY, Bromont (CA); Jérôme-Olivier MALO, Granby (CA)

(21) Appl. No.: 18/720,467

(22) PCT Filed: Dec. 13, 2022
(86) PCT No.: PCT/IB2022/062161

§ 371 Date: Jun. 14, 2024

Related U.S. Application Data
(60) Provisional application No. 63/290,764, filed on Dec. 17, 2021.

(51) Int. Cl. H01F 21/08; H01F 3/10; H01F 21/06

(52) U.S. Cl. CPC H01F 21/08; H01F 21/06; H01F 3/10; H01F 2003/106

(57) ABSTRACT

An assembly for varying inductance, the assembly comprising a stator configured to produce at least one pair of magnetically opposed poles, a line extending from one pole of the at least one pair of magnetic poles to a remaining pole of the at least one pair of poles defining a first direction, and a rotor adjacent to the stator. The rotor includes a rotor body formed from a first material having a first effective magnetic permeability, the rotor body defining a plurality of recesses extending parallel to a rotation axis of the rotor, the rotation axis extending along the first direction, and a plurality of bars formed from a second material and disposed within the plurality of recesses, the second material having a second effective magnetic permeability, a rotation of the rotor about the rotation axis causes a periodical alternation of inductance of the assembly.

### CROSS-REFERENCE TO RELATED APPLICATIONS

The present application claims priority to U.S. Patent Application No. 63/290,764 titled “SYSTEM FOR PARAMETRIC RESONANT VARYING INDUCTANCE”, filed Dec. 17, 2021, the entirety of which is incorporated by reference herein.

### TECHNICAL FIELD

The present disclosure relates to the field of electric components having variable inductance, and in particular to a parametric resonant inductor.

### BACKGROUND

In many technologies, inductive devices such as motors, linear actuators, solenoids, and induction coils rely on magnetic field generation to perform motoring, transforming and/or inducing action, or magnetic attraction or repulsion. In known approaches, said inductive devices and other devices cooperatively operating therewith do not necessarily recover and/or reuse magnetic field energy. Indeed, in many technologies, the magnetic field is treated as a nuisance to be diminish.

In some early proposed work, however, it is proposed that excitation of oscillations in an electric oscillatory system can be performed via magnetic field energy induction (On The Parametric Excitation Of Electric Oscillations, L. I Mandelstam, N. D. Papalexi, University of California, 1934)

Consequently, system and electric component assemblies for recycling magnetic field energy are desirable.

### SUMMARY

An aspect of the present disclosure is to provide an assembly for varying inductance, the assembly comprising a stator configured to produce at least one pair of magnetically opposed poles, a line extending from one pole of the at least one pair of magnetic poles to a remaining pole of the at least one pair of poles defining a first direction and a rotor adjacent to the stator. The rotor includes a rotor body formed from a first material having a first effective magnetic permeability, the rotor body defining a plurality of recesses extending parallel to a rotation axis of the rotor, the rotation axis extending along the first direction, and a plurality of bars formed from a second material, each bar being disposed within one of the plurality of recesses, the second material having a second effective magnetic permeability, the rotor being arranged relative to the stator such that rotation of the rotor about the rotation axis causes a periodical alternation of inductance of the assembly.

In at least one embodiment, the plurality of bars forms a portion of an exterior surface of the rotor.

In at least one embodiment, the plurality of bars extends substantially parallel the rotation axis such that a given bar of the plurality of bars periodically faces magnetically opposed poles of the at least one pair of magnetic poles simultaneously.

In at least one embodiment, the first effective magnetic permeability is at least ten times lower than the second effective magnetic permeability.

In at least one embodiment, the first material is a non-ferromagnetic material.

In at least one embodiment, the second material is a ferromagnetic material.

In at least one embodiment, the stator comprises at least one wire coil, the at least one pair of magnetic poles are formed by the at least one coil.

In at least one embodiment, the at least one wire coil is a single wire coil producing a single pair of magnetic poles.

In at least one embodiment, the at least one wire coil includes a plurality of wire coils, the plurality of wire coils are connected in series, and each wire coil of the plurality of coils produces one pair of magnetically opposed poles.

In at least one embodiment, the plurality of coils simultaneously faces one bar of the plurality of bars upon rotation of the rotor about the rotation axis, each coil facing a respective one bar of the plurality of bars.

In at least one embodiment, the assembly is electrically connected to a capacitor, thereby forming an electric circuit, and a rotation speed of the rotor about the rotation axis is set such that a frequency of alternation of the inductance of the assembly is twice an eigenfrequency of the electric circuit.

In at least one embodiment, the assembly further comprises an actuator operatively coupled to the rotor for providing rotation of the rotor.

In at least one embodiment, the first material is selected from a group of material comprising wood, plastics, aluminum, and brass.

In at least one embodiment, the second material is selected from a group of material comprising ferrite and permalloy.

In at least one embodiment, the stator has a hollow cylindrical shape extending along the first direction, the at least one pair of magnetically opposed poles being produced on an interior surface of the stator, and the rotor rotates within the stator.

In at least one embodiment, the rotor body has a cylindrical shape extending along the first direction and centered within the stator.

In at least one embodiment, the plurality of recesses substantially extends along at least a majority of a length of the rotor body on a rounded exterior surface thereof and the plurality of recesses are defined equidistant to one another.

In at least one embodiment, the rotor is disposed close enough to the stator such that the at least one pair of magnetically opposed poles magnetically interacts with the rotor body and the plurality of bars upon rotation of the rotor around the rotation axis.

Another aspect of the present disclosure is to provide an assembly for varying inductance, the assembly comprising at least one wire coil configured to produce, in use, a pair of magnetically opposed poles, a variable magnetic permeability component comprising a first portion formed from a first material having a first effective magnetic permeability, and a second portion formed from a second material having a second effective magnetic permeability, the variable magnetic permeability component being operatively connected to an actuator which, upon actuation of the variable magnetic permeability component, causes periodically alternating disposal of the first material and the second material in front of the at least one wire coil such that the magnetically opposed poles simultaneously face one of the first and second material, thereby periodically varying an inductance of the at least one wire coil.

In at least one embodiment, the first effective magnetic permeability is at least ten times lower than the second effective magnetic permeability.

In at least one embodiment, the second material is a ferromagnetic material.

In at least one embodiment, the first material is a non-ferromagnetic material.

In at least one embodiment, the at least one wire coil includes a plurality of wire coils connected in series, and the plurality of coils is disposed such that, upon movement of the variable magnetic permeability component, the plurality of coils simultaneously faces parts of the second portion of the variable magnetic permeability component.

In at least one embodiment, the at least one wire coil is electrically connected to a capacitor, thereby forming an electric circuit, a frequency of the alternating disposal of the first material and the second material in front of the at least one wire coil being twice an eigenfrequency of the electric circuit.

In at least one embodiment, the first material is selected from a group of material comprising wood, plastics, aluminum, and brass.

In at least one embodiment, the second material is selected from a group of material comprising ferrite and permalloy.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims

### BRIEF DESCRIPTION OF THE FIGURES

The features and advantages of the present disclosure will become apparent from the following detailed description, taken in combination with the appended drawings, in which:

FIG. 1 is a schematic diagram of an assembly for varying inductance according to an embodiment of the present technology;

FIG. 2 is a schematic diagram of the assembly of FIG. 1 implemented in an electric circuit;

FIG. 3A is a perspective view of a rotor of an assembly for varying inductance according to another embodiment of the present technology;

FIG. 3B is a perspective view of the rotor of FIG. 3A, with a bar of material disposed therein;

FIG. 4 is a perspective view of a stator of an assembly for varying inductance according to another embodiment of the present technology;

FIG. 5 illustrates a schematic, cross-sectional diagram of an assembly for varying inductance including the rotor of FIGS. 3A,3B and the stator of FIG. 4;

FIG. 6 is a schematic diagram of the assembly of FIG. 5 implemented in an electric circuit according to another embodiment of the present technology; and

FIG. 7 an electric diagram of the assembly of FIG. 5 implemented in an electric circuit according to yet another embodiment of the present technology.

It is to be understood that throughout the appended drawings and corresponding descriptions, like features are identified by like reference characters. Furthermore, it is also to be understood that the drawings and ensuing descriptions are intended for illustrative purposes only and that such disclosures are not intended to limit the scope of the claims.

### DETAILED DESCRIPTION

Various representative embodiments of the disclosed technology will be described more fully hereinafter with reference to the accompanying drawings, in which representative embodiments are shown. The presently disclosed technology may, however, be embodied in many different forms and should not be construed as limited to the representative embodiments set forth herein. Rather, these representative embodiments are provided so that the disclosure will be thorough and complete, and will fully convey the scope of the present technology to those skilled in the art. In the drawings, the sizes and relative sizes of layers and regions may be exaggerated for clarity. Like numerals refer to like elements throughout. And, unless otherwise defined, all technical and scientific terms used herein have the same meaning as commonly understood by one of ordinary skill in the art to which the described embodiments pertain.

The present disclosure introduces an assembly for varying inductance. In a first embodiment, the assembly includes at least one wire coil configured to produce, in use, a pair of magnetically opposed poles. The assembly also includes a variable magnetic permeability component including a first and a second portions having a first and second effective magnetic permeability respectively. The variable magnetic permeability component is actuated such that the first and second portions are periodically alternatively disposed in front of the at least one wire coil, there periodically varying an inductance of the at least one wire coil. In one embodiment, the assembly is connected in series to a capacitor, thereby forming a resonant electric circuit having an eigenfrequency, the variable magnetic permeability component being actuated such that frequency of the alternating disposal of the first and second portions in front of the at least one wire coil is twice the eigenfrequency of the electric circuit. In some instances, the alternating disposal being twice the eigenfrequency causes resonant power amplification in the electric circuit. The electric circuit may be further connected to a load for providing electric power thereto.

In the same or another embodiment, the assembly may include a stator configured to produce at least one pair of magnetically opposed poles, and a rotor including a rotor body and a plurality of bars disposed on the rotor body, the bars having an effective magnetic permeability different than an effective magnetic permeability of the rotor body. Upon rotation of the rotor in front of the at least one pair of magnetically opposed poles, an inductance of the assembly periodically varies. In one embodiment, the assembly is electrically connected to a capacitor in series, thereby forming a resonant electric circuit. In this embodiment, the frequency of alternation of the inductance of the assembly may be set as twice an eigenfrequency of the electric circuit, thereby causing resonant power amplification in the electric circuit. The electric circuit may be further connected to a load for providing electric power thereto. Illustrative embodiments of the assembly are described in greater details herein further below.

Generally speaking, the present disclosure introduces an assembly having an inductance that oscillates around a mean inductance value, the assembly being configured to allow fine tuning of a frequency of the oscillations. The frequency of the oscillations may be set to generate resonance in an electric circuit, thereby causing resonant power amplification in the electric circuit.

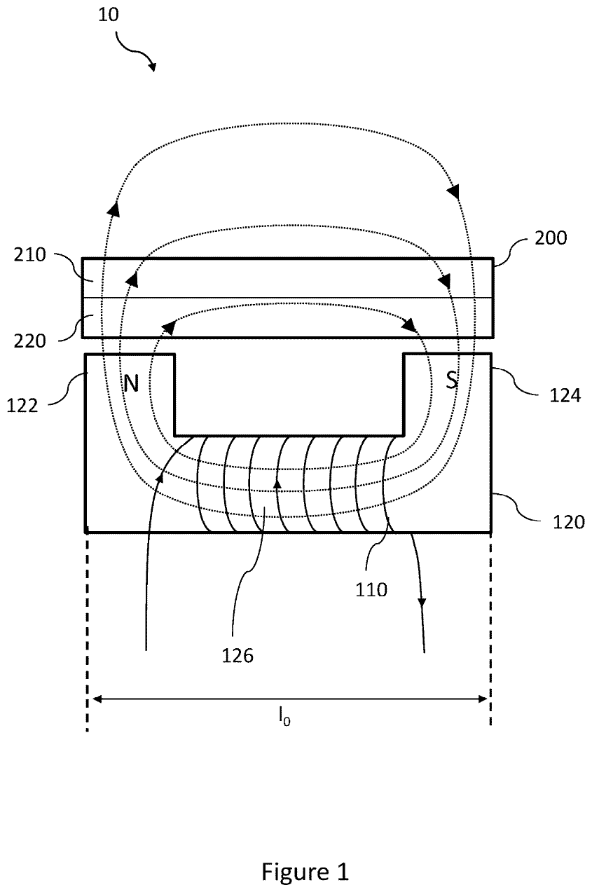

Referring now to the drawings, FIG. 1 is a schematic diagram of an assembly 10 for varying inductance. The assembly 10 includes a wire coil 110 wound around a U-shaped core 120. More specifically, the wire coil 110 is wound around a central portion 126 of the U-shaped core 120, the central portion 126 extending between a first end 122 and a second end 124 of the U-shaped core 120. The wire coil 110 may be formed of copper.

The U-shaped core 120 is shaped to orient the magnetic field in a given manner. Alternative shape of the core 120 are contemplated in alternative embodiments, this aspect is not limitative. The U-shaped core 120 may be made of, for example an without limitation, permalloy or Mu-metal (Ni—Fe). In the context of the present disclosure, an effective magnetic permeability of a material forming the U-shaped core 120 is noted μᵣ₀.

Upon electric current flowing in the wire coil 110, a magnetic field is generated by the wire coil 110, represented by three magnetic field lines depicted in FIG. 1, with a pair of magnetically opposed poles being formed at ends of the U-shaped core 120. In the illustrative example of FIG. 1, a North magnetic pole is produced at the first end 122 and a South magnetic pole is produced at the second end 124. Polarity of the magnetic poles at the first and second ends 122, 124 of the U-shaped core 120 depends on a direction of the electric current in the wire coil 110.

The assembly 10 further includes a variable magnetic permeability component 200 disposed in front of the first and second ends 122, 124 of the U-shaped core 120. The variable magnetic permeability component 200 includes a first portion 210 formed from a first material having a first effective magnetic permeability, and a second portion 220 formed from a second material having a second effective magnetic permeability. Illustrative examples of the variable magnetic permeability component 200 are described in greater detail below. In the context of the present disclosure, an effective magnetic permeability of the first material is noted μᵣ₁, and an effective magnetic permeability of the second material is noted μᵣ₂. In this embodiment, the first and second material are selected such that one of the first and second materials has an effective magnetic permeability significantly higher than the other one of the first and second materials. As an example, the first and second materials may be selected such that μᵣ₂≥10μᵣ₁. In this embodiment, the first material is a non-ferromagnetic material and the second material is a ferromagnetic material.

The variable magnetic permeability component 200 is operatively connected to an actuator (not shown) which, upon actuation of the variable magnetic permeability component 200, causes periodically alternating disposal of the first and second material in front of the first and second ends 122, 124 of the U-shaped core 120 simultaneously. In the context of the present disclosure, a frequency of said alternation is noted f₁. As an example, on a position of the variable magnetic permeability component 200 in FIG. 1, the second portion 220 in front of both of the first and second ends 122, 124. In other words, the magnetically opposed poles produced by the wire coil 110 are both simultaneously in front of either the first or the second material of the variable magnetic permeability component 200.

As the material disposed in the front of the magnetically opposed poles of the wire coil 110 periodically varies, the magnetic field produced by the assembly 10 is periodically altered. More specifically, the magnetic field exerts a magnetic force on the variable magnetic permeability component 200 which is countered by actuation of the variable magnetic permeability component 200. The magnetic force may be expressed as: F_{mag}=V̅(M·B) where B is the magnetic field and M is a magnetic moment induced in the variable magnetic permeability component 200. Periodic alternating positioning of the first and second material in front of the first and second ends 122, 124 thereby causes a periodic alternation of the inductance of the assembly 10.

More specifically, the inductance of the assembly periodically alternates between a high-inductance value Lₘₐₓ and a low-inductance value Lₘᵢₙ at the frequency f₁, the high-inductance and low-inductance values being expressed as:

$${L}_{max} = \frac{N}{\frac{{l}_{0}}{{μ}_{0} {μ}_{r 0} {A}_{0}} + \frac{{l}_{2}}{{μ}_{0} {μ}_{r 2} {A}_{2}}}$$

$$and$$

$${L}_{min} = \frac{N}{\frac{{l}_{0}}{{μ}_{0} {μ}_{r 0} {A}_{0}} + \frac{{l}_{1}}{{μ}_{0} {μ}_{r 1} {A}_{1}}}$$

where μ₀ is the magnetic permeability of free space, N is a number of turns in the wire coil 110, A₀ is a cross-sectional area of the wire coil 110, A₁ is a cross-sectional area of the first portion 210, A₂ is a cross-sectional area of the second portion 220, l₀ is a length of the U-shaped core 120, h is a length of the first portion 210, and 12 is a length of the second portion 220. In the illustrative example of FIG. 1, l₀, l₁ and l₂ are equal.

In some embodiments, the assembly 10 could include a plurality of wire coils similar to the wire coil 110 and connected in series, each wire coil producing a respective pair of magnetically opposed poles. In such an embodiment, the wire coils 110 are disposed in such manner that one of the first and second portions 210, 220 of the variable magnetic permeability component 200 is alternately in front of the all of the produced magnetic poles simultaneously. An illustrative embodiment of an assembly for varying inductance including a plurality of pairs of magnetically opposed poles is described in greater detail below.

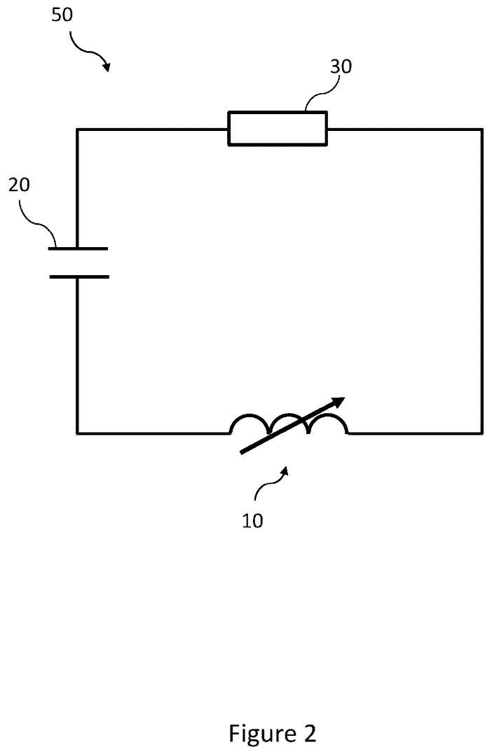

FIG. 2 is a diagram of the assembly 10 electrically connected to a capacitor 20 having a capacitance C, thereby forming a resonant electric circuit 50. A component 30 having a resistivity R in the electric circuit 50 represents the internal inherent resistivity of the resonant electric circuit 50 (i.e. a resistivity of the assembly 10, of the capacitor 20 and of electric wires connecting the components of the electric circuit 50). Indeed, the assembly 10 having an inductance L(t), the resonant electric circuit 50 is resonant at an eigenfrequency noted f₀. The eigenfrequency f₀ depends at least in part on the values of the resistivity R, the capacitance C and an average inductance Lₐᵥ of the assembly 10. In this embodiment, Lₐᵥ=(Lₘₐₓ+Lₘᵢₙ)/2. Moreover, an energy collected in the assembly 10 may be expressed as:

$$E ( t ) = \frac{1}{2} L ( t ) \cdot {i ( t )}^{2}$$

where i(t) is the electric current flowing in the circuit 50.

In use, an actuation of the variable magnetic permeability component 200 alters the magnetic filed produced by the wire coil 110. In an absence of a power generating device in the electric circuit 50, random charges in the circuit 50 due to statistical fluctuations may still generate a magnetic field having a relative magnitude high enough to periodically altered by the varying magnetic permeability disposed in front of the wire coil 110 upon actuation of the variable magnetic permeability component 200. Energy of actuation of the variable magnetic permeability component 200 is thus converted in magnetic energy through the assembly 10 and may be subsequently stored by the capacitor 20 under the form of electrostatic energy.

In this embodiment, the capacitor C is generally empty of charge upon starting actuation the variable magnetic permeability component 200. In other words, a charge Q(t) stored by the capacitor is null: Q(t=0)=0. In alternative embodiments, the capacitor may be charged prior actuation of the variable magnetic permeability component 200: Q (t=0)=Q₀>0.

In this embodiment, the frequency f₁ of alternating disposal of the first and second material in front of the first and second ends 122, 124 (i.e. the frequency of variation of the inductance L(t) of the assembly 10) is set to be twice the eigenfrequency of the electric circuit 50, such that: f₁=2f₀.

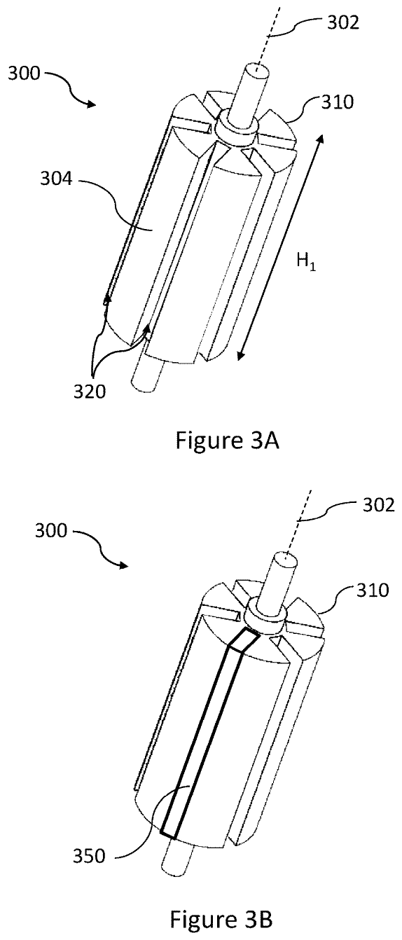

FIGS. 3A and 3B are a perspective view of a rotor 300 of an assembly for varying inductance such as the assembly 10. In this embodiment, the rotor 300 includes a rotor body 310 made of a first material having a first effective magnetic permeability. The first material made be, for example and without limitation, formed of wood, plastics, aluminium, or brass. Broadly speaking, in this embodiment, the first material may be any non-ferromagnetic, rigid material having an effective relative magnetic permeability close to 1. The rotor body 310 is made of an integral single piece of the first material in this embodiment but may be made of different pieces in alternative embodiments. As an example, the rotor body 310 may be formed using injection molding techniques.

In this embodiment, the rotor 300 has a cylindrical shape extending along a main direction defined along a rotation axis 302. In use, the rotor 300 is actuated by an actuator (e.g. a motor) to rotate around the rotation axis 302. The rotor body 310 defines therein a plurality of recesses 320 extending on a rounded exterior surface of the rotor body 310 on at least a majority of a length H₁ of the rotor body. The recesses 320 define a substantially rectangular-extending shape, extending parallel to the rotation axis 302. In this embodiment, the recesses 320 are defined equidistant to one another on the rounded exterior surface 304. More specifically, distances between two consecutive recesses 320 along the rounded exterior surface 304 and orthogonally to the rotation axis 302 are equal to one another.

As best shown on FIG. 3B, the rotor 300 also includes a plurality of bars 350 (only one of which is illustrated) formed of a second material having a second effective magnetic permeability. The bars 350 are contained in the recesses 320 such that each one of the bars 350 is disposed within a respective one of the recesses 320. The bars 350 may be maintained in the recesses by fixing members, glue, or any other component suitable for maintaining the bars 350 within the recesses 320.

The second material is selected from a group of materials including ferrite and permalloy. Broadly speaking, in this embodiment, the second material may be any ferromagnetic, rigid material without permanent magnetization properties and having an effective magnetic permeability higher than 1000. In this embodiment, the second material forming the bars 350 is a ferromagnetic material and the second effective magnetic permeability is at least ten times higher than the first effective magnetic permeability of the rotor body 310. In an alternative embodiment, the rotor 300 could have a unique recess 320 and a unique bar 350 disposed within the unique recess 320. A number of recesses 320 and bars 350 is not limitative.

As an example, the variable magnetic permeability component 200 of the assembly 10 for varying inductance may be implemented as the rotor 300 in a non-limiting embodiment of the present technology.

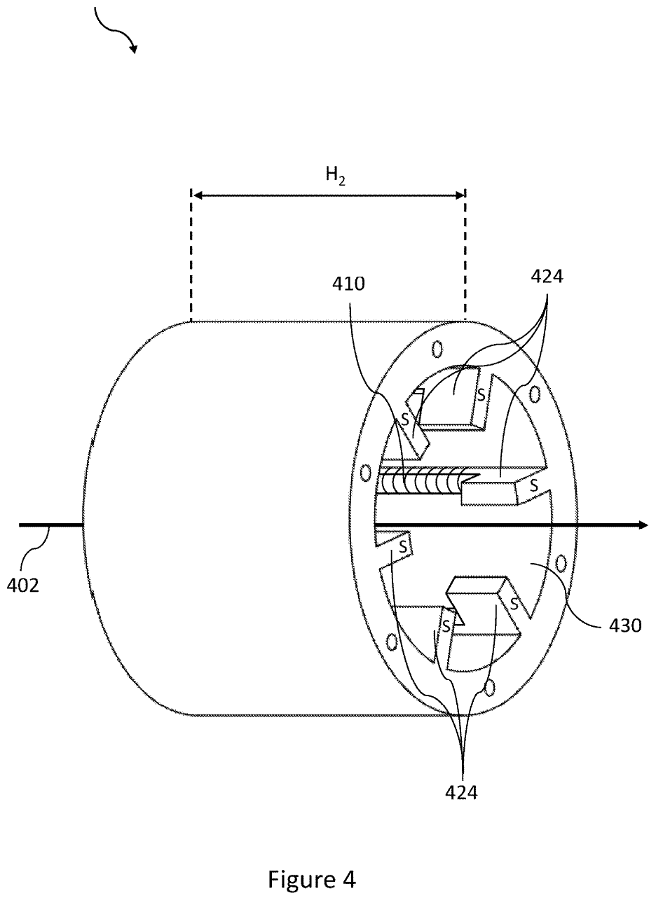

FIG. 4 is a perspective view of a stator 400 of an assembly for varying inductance according to an embodiment of the present technology. The stator 400 is configured to produce at least one pair of magnetically oppose poles. To do so, the stator 400 includes, in this embodiment, at least one wire coil 410 that, upon electric current flowing within, produces at least one corresponding pair of magnetically oppose poles. The wire coil 410 may be formed of copper. In the illustrative embodiment of FIG. 4, the stator 400 includes six wire coils 410 (only one of which being visible). Each wire coil 410 forms a pair of magnetically opposed poles during operation, each pair forming specifically a North pole (not visible) and a South pole 424. The six wire coils 410 are connected in series. The stator 400 may include a different number of wire coils 410 in alternative embodiments, including for example a unique wire coil 410.

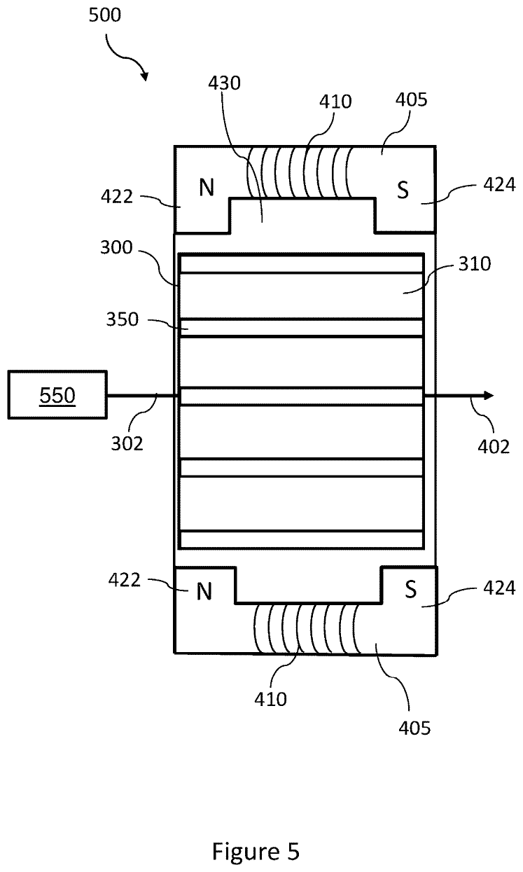

In the illustrated embodiment, the stator 400 has a hollow cylindrical shape extending along a main direction defined along a main axis 402, a length H₂ of the stator 400 being defines along the main axis 402. Moreover, the stator 400 defines, on an internal surface 430 thereof, a plurality of inductance cores that may be similar in shape to the U-shaped core 120 of the assembly 10 (see FIG. 5) configured to maintain the wire coils 410. Each inductance core 405 has a corresponding one of the wire coils 410 wound around a main portion thereof. The wire coils 410 are equidistant to another along the internal surface 430 and orthogonally to the main axis 402.

In this embodiment, the wire coils 410 are wound and the inductance cores 405 are shaped such that a line extending from one pole of each pair of magnetic poles to a remaining pole of the same pair of poles extends parallel to the main axis 402. In other words, a distance between the magnetically opposed poles of each pair extends along the height H₂ of the stator 400 (i.e. along the main direction defined by the main axis 402).

FIG. 5 is a schematic diagram of an assembly 500 for varying inductance including the rotor 300 and the stator 400. More specifically, the rotor 300 is disposed within the stator 400 such that the rotation axis 302 of the rotor 300 is aligned with the main axis 402. The rotor 300 is thus centered within the stator 400 and rotates, in use, about the main axis 402 of the stator 400. The assembly 500 may further include an actuator 550 operatively coupled to the rotor 300 for providing rotation of the rotor 300 about the rotation axis 302. Operative coupling between the actuator 550 and the rotor 300 could include, for example and without limitation, magnetic bearings to reduce friction during transmission of a coupling force from the actuator 550 to the rotor 300. The actuator 550 may be for example an electric motor, a reciprocating engine, a propeller or any blade arrangement rotating due to a flow of a fluid (e.g. air or water) thereagainst. The rotation of the rotor 300 may be for example caused by, via the actuator 550, natural convection of ambient air flowing through the actuator 550 and inducing a rotation thereof. The rotation of the rotor 300 may be provided by another actuating component in alternative embodiments.

In this embodiment, the number of bars 350 included in the rotor 300 is equal to a number of pairs of magnetically opposed poles produced by the stator 400. The number of bars 350 may be higher to the number of pairs of magnetically opposed poles in alternative embodiments.

The bars 350 and the wire coils 410 are disposed such that, in use (i.e. upon rotation of the rotor 300 about the rotation axis 302), each bar 350 is successively and periodically disposed in front of each pair of magnetically opposed poles produced by the stator 400 such that both poles of a same pair are simultaneously in front of the bar 350. In other words, the magnetic poles of a same pair of magnetically opposed poles produced by a same one of the wire coils 410 are periodically and simultaneously in front of a same one of the bars 350. Moreover, in this embodiment, geometrical dimensions of the rotor 300 and the stator 400 are set such that, upon rotation of the rotor 300 about the rotation axis 302, the rounded external surface 304 and the plurality of bars 350 are disposed close enough to the wire coils 410 and/or to a first and second ends of the inductance cores defined by the stator 400 such that the magnetically opposed poles generally magnetically interact with the rotor body 310 and the plurality of bars 350. As an example, a distance, measured orthogonally to the rotation axis 302, between a given wire coil 410 and the rotor 300 is one millimeter. Broadly speaking, the rotor 300 is disposed within the stator 400 such that, upon rotation of the rotor 300 about the rotation axis 302, a magnitude of the magnetic force applied by a given one of the wire coils 410 on a closest portion of the rotor 300 (i.e. one of the bars 350 of a portion of the rotor body 310) upon rotation thereof is above a pre-determined threshold, thereby ensuring magnetic interaction between the wire coils 410 and the rotor 300. As such, the rotor 300 may be said to be adjacent to the stator 400.

Moreover, the bars 350 and the wire coils 410 are disposed such that, in use, all the pairs of magnetically opposed poles produced by the stator 400 face one of the bars 350 simultaneously. As described for the assembly 10 in FIG. 1, the same principle and calculations apply to an inductance L′(t) of the assembly 500 for varying inductance, such that L′(t) periodically varies between a high-inductance value L′ₘₐₓ and a low-inductance value L′ₘᵢₙ, which can be expressed as:

$${L}_{max}^{′} = m \cdot \frac{N}{\frac{{l}_{0}^{′}}{{μ}_{0} {μ}_{r 0}^{′} {A}_{0}^{′}} + \frac{{l}_{2}^{′}}{{μ}_{0} {μ}_{r 2}^{′} {A}_{2}^{′}}}$$

$$and$$

$${L}_{min}^{′} = m \cdot \frac{{N}^{′}}{\frac{{l}_{0}^{′}}{{μ}_{0} {μ}_{r 0}^{′} {A}_{0}^{′}} + \frac{{l}_{1}^{′}}{{μ}_{0} {μ}_{r 1}^{′} {A}_{1}^{′}}}$$

where μ₀ is the magnetic permeability of free space, μ′ᵣ₀ is an effective magnetic permeability of the material forming the stator 400, μ′ᵣ₂ is an effective magnetic permeability of the material forming the bars 350, μ′ᵣ₁ is an effective magnetic permeability of the material forming the rotor body 310, N′ is a number of turns in the wire coils 410, m is a number of wire coils 410 (i.e. a number of pairs of magnetically opposed poles produced by the stator 400), A₀′ is an area of a cross section of the wire coils 410, A₁′ is an area of a cross section of the rotor body 310, A₂′ is an area of a cross section of a given bar 350, l₀′ is a length of the inductance cores 405 along the main axis 402, l₁′ is a length of the rotor body 310 along the main axis 402 and l₂′ is a length of the bars 350 along the main axis 402.

In this embodiment, the effective magnetic permeability of the inductance cores 405 and the effective magnetic permeability of the bars 350 are equal (i.e. μ′ᵣ₀=μ′ᵣ₂). Moreover, the cross-sectional area A′₀ of the inductance cores 405 is equal to the cross-sectional area A′₂ of the bars 350. The high-inductance value L′ₘₐₓ can therefore be expressed as:

$${L}_{max}^{′} = m \cdot \frac{N}{\frac{{l}_{0}^{′} + {l}_{2}^{′}}{{μ}_{0} {μ}_{r 0}^{′} {A}_{0}^{′}}} .$$

As such, the inductance of the assembly 500 may be expressed as:

$${L}^{′} ( t ) = {L}_{0}^{′} + Δ L \cdot cos ( {ω}_{1} t - φ ) ,$$

where L′₀ is an average value of the inductance of the assembly 500, ΔL is an amplitude of the variations of the inductance such that ΔL=(Lₘₐₓ−Lₘᵢₙ)/2, ω₁=2πf₁, f₁ being a frequency of the variation of the inductance of the assembly 500 and depending, inter alia, on the number of wire coils 410. In this embodiment, f₁=m′·fᵣₒₜ, where fᵣₒₜ=ωᵣₒₜ/2π, ωᵣₒₜ is a rotational speed of the rotor 300 about the rotation axis 302. In at least some embodiments, m′ is higher than m.

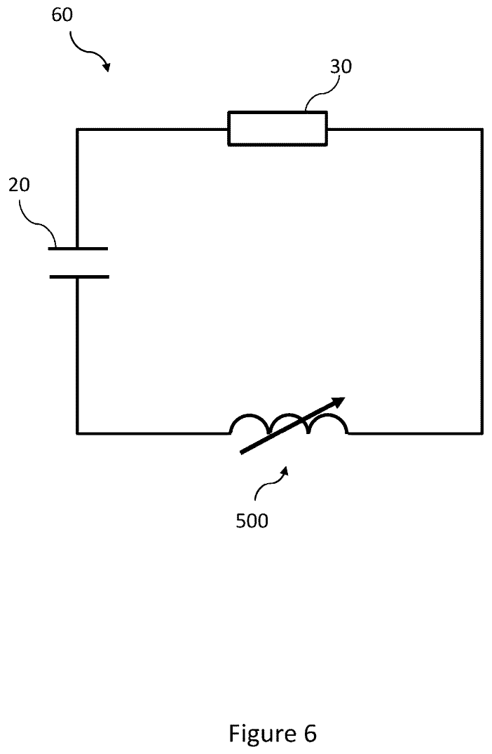

FIG. 6 is an electric diagram of the assembly 500 electrically connected the capacitor 20 having a capacitance C, thereby forming a resonant electric circuit 60. In this embodiment, the component 30 accounts for internal inherent resistivity of the resonant electric circuit 60 (i.e. a resistivity of the assembly 500, of the capacitor 20 and of electric wires connecting the components of the electric circuit 60). Indeed, the assembly 500 having an inductance L′(t), the resonant electric circuit 60 is resonant at an eigenfrequency noted f′₀. The eigenfrequency f′₀ depends at least in part on the values of the resistivity R, the capacitance C and the average inductance L′₀ of the assembly 500.

In this embodiment, the eigenfrequency f′₀ may be expressed as:

$${f}_{0}^{′} = \frac{1}{2 π} \sqrt{\frac{1}{{CL}_{0}^{′}} - \frac{{R}^{2}}{4 {L}_{0}^{′}}} .$$

The energy collected by the wire coils 410 of the assembly 500 may thus be expressed as

$$E ( t ) = \frac{1}{2} {L}_{0}^{′} \cdot {i ( t )}^{2} + \frac{1}{2} Δ L \cdot cos ( {ω}_{1} t - φ ) \cdot {i ( t )}^{2} ,$$

where i(t) is the electric current flowing in the circuit 60 and φ is an arbitrary constant phase.

In this embodiment, the rotational speed of the stator 300 is set such that f₁=2·f′₀ thereby matching a resonance of the electric circuit 60. As such, the magnetic energy received by the assembly 500 is increased when |i(t)| increases during oscillations thereof compared to a non-varying inductance. Energy of actuation of the rotor 300 is thus converted in magnetic energy through the assembly 500 and may be subsequently stored by the capacitor 20 under the form of electrostatic energy.

In this embodiment, the capacitor C is empty of charge upon starting actuation the variable magnetic permeability component 200. In other words, a charge Q(t) stored by the capacitor is null: Q(t=0)=0. In alternative embodiments, the capacitor may be charged prior actuation of the rotor 300: Q(t=0)=Q₀>0.

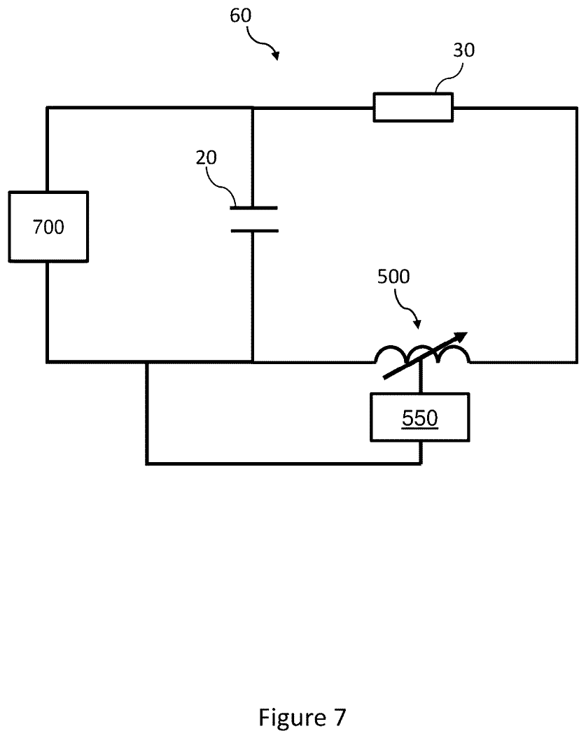

As shown in the illustrative embodiment of FIG. 7, the electric circuit 60 further includes a load 700 to be powered. The load 700 may be, for example, connected in parallel to the capacitor 20 such that electrostatic energy is transferred from the capacitor 20 to the load 700. Electric power is thus provided by the circuit 60 to the load 700. The load 700 may be, for example and without limitation, a car engine, or any other load that may be provided with electrical power.

In at least some embodiments, the actuator 550 providing rotation of the rotor 300 about the rotation axis 302 is electrically connected to the circuit 60 such that electric power input of the actuator 550 is partly provided by the electric circuit 60 itself. As an example, the circuit 60 may be implemented into a windmill, a wind kinetic energy providing, at least in part, input energy of the actuator 550 such that the rotation of the rotor 300 about the rotation axis 302 may be initiated. Therefore, resonant oscillations of the current are produced in the electric circuit 60, an electric energy collected by the capacitor 20 may further be transferred the load 700 (e.g. a windmill motor). In use, energy received from the kinetic energy of the wind may thus by used to operate the actuator 550 of the assembly 500 and/or be collected for storage thereof, the windmill thus operating without standard electric power source.

It will be understood that, although the embodiments presented herein have been described with reference to specific features and structures, it is clear that various modifications and combinations may be made without departing from such disclosures. The specification and drawings are, accordingly, to be regarded simply as an illustration of the discussed implementations or embodiments and their principles as defined by the appended claims, and are contemplated to cover any and all modifications, variations, combinations or equivalents that fall within the scope of the present disclosure.

1. An assembly for varying inductance, the assembly comprising:
a stator configured to produce at least one pair of magnetically opposed poles, a line extending from one pole of the at least one pair of magnetic poles to a remaining pole of the at least one pair of poles defining a first direction; and
a rotor adjacent to the stator, the rotor including:
a rotor body formed from a first material having a first effective magnetic permeability, the rotor body defining a plurality of recesses extending parallel to a rotation axis of the rotor, the rotation axis extending along the first direction;
a plurality of bars formed from a second material, each bar being disposed within one of the plurality of recesses, the second material having a second effective magnetic permeability,
the rotor being arranged relative to the stator such that rotation of the rotor about the rotation axis causes a periodical alternation of inductance of the assembly.

2. The assembly of claim 1, wherein the plurality of bars forms a portion of an exterior surface of the rotor.

3. The assembly of claim 1, wherein the plurality of bars extends substantially parallel the rotation axis such that a given bar of the plurality of bars periodically faces magnetically opposed poles of the at least one pair of magnetic poles simultaneously.

4. The assembly of claim 1, wherein the first effective magnetic permeability is at least ten times lower than the second effective magnetic permeability.

5. The assembly of claim 1, wherein the first material is a non-ferromagnetic material.

6. The assembly of claim 1, wherein the stator comprises at least one wire coil, the at least one pair of magnetic poles are formed by the at least one coil.

7. The assembly of claim 6, wherein the at least one wire coil is a single wire coil producing a single pair of magnetic poles.

8. The assembly of claim 6, wherein:
the at least one wire coil includes a plurality of wire coils;
the plurality of wire coils is connected in series; and
each wire coil of the plurality of coils produces one pair of magnetically opposed poles,
the plurality of coils simultaneously facing one bar of the plurality of bars upon rotation of the rotor about the rotation axis, each coil facing a respective one bar of the plurality of bars.

9. (canceled)

10. The assembly of claim 1, wherein: the assembly is electrically connected to a capacitor, thereby forming an electric circuit; and a rotation speed of the rotor about the rotation axis is set such that a frequency of alternation of the inductance of the assembly is twice an eigenfrequency of the electric circuit.

11. The assembly of claim 1, further comprising an actuator operatively coupled to the rotor for providing rotation of the rotor.

12. The assembly of claim 1, wherein the first material is selected from a group of material comprising wood, plastics, aluminum, and brass.

13. The assembly of claim 1, wherein the second material is selected from a group of material comprising ferrite and permalloy.

14. The assembly of claim 1, wherein:
the stator has a hollow cylindrical shape extending along the first direction;
the at least one pair of magnetically opposed poles being produced on an interior surface of the stator; and
the rotor rotates within the stator.

15. The assembly of claim 1, wherein the rotor body has a cylindrical shape extending along the first direction and centered within the stator.

16. (canceled)

17. The assembly of claim 1, wherein the rotor is disposed close enough to the stator such that the at least one pair of magnetically opposed poles magnetically interacts with the rotor body and the plurality of bars upon rotation of the rotor around the rotation axis.

18. An assembly for varying inductance, the assembly comprising:
at least one wire coil configured to produce, in use, a pair of magnetically opposed poles;
a variable magnetic permeability component comprising:
a first portion formed from a first material having a first effective magnetic permeability, and
a second portion formed from a second material having a second effective magnetic permeability,
the variable magnetic permeability component being operatively connected to an actuator which, upon actuation of the variable magnetic permeability component, causes periodically alternating disposal of the first material and the second material in front of the at least one wire coil such that the magnetically opposed poles simultaneously face one of the first and second material, thereby periodically varying an inductance of the at least one wire coil.

19. The assembly of claim 18, wherein the first effective magnetic permeability is at least ten times lower than the second effective magnetic permeability.

20. The assembly of claim 18, wherein the second material is a ferromagnetic material.

21. The assembly of claim 18, wherein:
the at least one wire coil includes a plurality of wire coils connected in series; and
the plurality of coils is disposed such that, upon movement of the variable magnetic permeability component, the plurality of coils simultaneously faces parts of the second portion of the variable magnetic permeability component.

22. The assembly of claim 18, wherein the at least one wire coil is electrically connected to a capacitor, thereby forming an electric circuit, a frequency of the alternating disposal of the first material and the second material in front of the at least one wire coil being twice an eigenfrequency of the electric circuit.

23.-24. (canceled)
